(19) United States
(12) Patent Application Publication
(10) Pub. No.: US 2007/0287848 A1
(43) Pub. Date: Dec. 13, 2007

(54) Silicon Compound Containi-Electron Conjugated-System Molecule and Process for Producing the Same

(76) Inventor: Masatoshi Nakagawa, Nara (JP)

Correspondence Address: NIXON & VANDERHYE, PC, 901 NORTH GLEBE ROAD, 11TH FLOOR, ARLINGTON, VA, 22203, US

(21) Appl. No.: 10/592,513

(22) PCT Filed: Mar. 3, 2004
(86) PCT No.: PCT/JP05/03648

§ 371 Date: Jun. 25, 2007

(30) Foreign Application Priority Data
Mar. 12, 2004 (JP) 2004-071016

(51) Int. Cl. C07F 7/02; C08G 77/00

(52) U.S. Cl. 556/400

(57) ABSTRACT

A π-electron conjugate molecule-containing silicon compound represented by the formula (I): 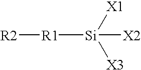 wherein R1 represents an organic group obtained by combining two or more units constituting plural π-electron conjugate systems, R2 represents a hydrophobic group and X1 to X3, which may be the same or different, respectively represent a group providing a hydroxyl group when it is hydrolyzed or a hydrogen atom.

### TECHNICAL FIELD

The invention relates to a n-electron conjugate molecule-containing silicon compound and a method of producing the same, and, particularly, to a π-electron conjugate molecule-containing silicon compound which is a conductive or semiconductive novel material useful as electronic materials and a method of producing the same.

### BACKGROUND ART

Besides semiconductors using inorganic materials, semiconductors (organic semiconductors) using organic compounds have been recently researched and developed and the results have been reported because these organic semiconductors are simply produced and easily processed, can correspond to the miniaturization of devices and is expected to attain cost reduction in mass-production, and as the organic compounds, various organic compounds having a more variety of functions than inorganic materials can be synthesized.

It is known that TFTs having large mobility can be produced by utilizing organic compounds containing a π-electron conjugate molecule among these organic materials. As this organic compound, pentacene is reported as a typical example (for example, IEEE Electron Device Lett., 18, 606-608 (1997): Non-patent Document 1). In this report, there is the description that when pentacene is used to produce a semiconductor layer, which is used to form a TFT, the field effect mobility is 1.5 cm²/Vs and it is therefore possible to produce a TFT having a larger mobility than amorphous silicon.

However, when an organic semiconductor layer having a higher field effect mobility than amorphous silicon as shown above is produced, a vacuum process such as a resistance heating vapor deposition method and a molecular beam vapor deposition method is required. This leads to the result that the production process is complicated and a crystalline film is obtained only under a specific condition. Also, this method has the problem that because the adsorption of the organic compound film to the substrate in the vacuum process is physical adsorption and therefore, the adsorption strength of the film to the substrate is so low that the film is easily peeled off. Generally, the orientation of a substrate on which the film is to be formed is controlled by rubbing treatment or the like to control the orientation of the molecules of the organic compound in the film to some extent. However, there has been no report concerning the fact that the conformity and orientation of a compound molecule at the boundary between the physically adsorbed organic compound film and the substrate can be controlled by the film formation by physical adsorption yet.

On the other hand, studies as to the regularity and crystallinity of a film which have a large influence on the field effect mobility that is a typical guide to the characteristics of a TFT have been recently made by utilizing a self-organizing film using an organic compound that is simply produced.

The self-organizing film means a film which is obtained by combining a part of an organic compound with a functional group present on the surface of a substrate, is very reduced in defects and has high orderliness, that is, high crystallinity. This self-organizing film is formed on the substrate with ease because it is produced by a very simple production method. Generally, a thiol film formed on a gold substrate and a silicon type compound film formed on a substrate (for example, a silicon substrate) are known as the self-organizing film, and the later substrate can be processed by hydrophilic treatment such that a hydroxyl group is allowed to project from its surface. Among these films, a silicon type compound film attracts remarkable attention from the viewpoint of high durability. The silicon type compound film is conventionally used as a water-repellent coating and is formed using a silane coupling agent containing, as organic functional groups, an alkyl group or fluorinated alkyl group having a high water-repellent effect.

However, the conductivity of the self-organizing film is determined by an organic functional group in a silicon type compound contained in the film. However, no commercially available silane coupling agent is found which contains a π-electron conjugate molecule as an organic functional group. It is therefore difficult to impart conductivity to the self-organizing film. There is therefore a strong demand for a silicon compound which is suitable to a device such as a TFT and contains a π-electron conjugate molecule as an organic functional group.

As such a silicon type compound, a compound is proposed which has one thiophene ring as a functional group on the terminal of a molecule, the thiophene ring being connected with a silicon atom through a straight-chain hydrocarbon group (for example, Japanese Patent No. 2889768: Patent Document 1).

Also, there is, for example, a proposal of a method of forming an antistatic film by a chemical deposition method as the self-organizing method using an organic molecule (for example, the publication of Japanese Unexamined Patent Publication No. HEI15 (1993)-202210: Patent Document 2). In this method, a conductive chemical adsorption film having a conductivity of 10⁻⁵ S/cm or more is formed on the surface of a substrate having a conductivity of 10⁻¹⁰ S/cm or less through a siloxane type monomolecular film.

[Non-patent Document 1] IEEE Electron Device Lett., 18, 606-608 (1997)

[Patent Document 1] Japanese Patent No. 2889768

[Patent Document 2] Japanese Unexamined Patent Publication No. HEI5 (1993)-202210

### DISCLOSURE OF INVENTION

### Problems that the Invention is to Solve

The compound proposed above ensures the production of a self-organizing film that can be chemically adsorbed to a substrate. However, it has unnecessarily ensured the production of a thin film having high orderliness, crystallinity and electroconductive characteristics enough to produce electronic devices such as TFTs.

In order to obtain high orderliness, that is, high crystallinity, it is necessary that high attracting interaction is exerted between molecules. The intermolecular force is constituted of an attractive factor and a repulsive factor, wherein the former is in inverse proportion to the 6th power of the distance between molecules and the latter is in inverse proportion to the 12th power of the distance between molecules. Therefore, the intermolecular force which is the sum of the attractive factor and the repulsive factor has the relationship as shown in FIG. 1. Here, the minimum point (the point indicated by the arrow in the figure) indicates the distance between molecules at which the highest attractive force is exerted between molecules in the balance between the attractive factor and the repulsive factor. Specifically, it is important that the intermolecular distance is made to be the closest to the minimum point to obtain high crystallinity. Therefore, originally, in a vacuum process such as a resistance heating vapor deposition method and a molecular beam vapor deposition method, a film having high orderliness, specifically, high crystallinity is obtained by well controlling the intermolecular interaction between π-electron conjugate molecules only in a certain specific condition. It is possible to develop high electroconductive characteristics only when the film has such the high crystallinity structured by intermolecular interaction.

On the other hand, the above compound has the possibility of forming a two-dimensional network of Si—O—Si so that it is chemically adsorbed to the substrate and also, the orderliness by the intermolecular interaction between specific long-chain alkyls is obtained. However, this compound has the problem that it has low intermolecular interaction because only one thiophene molecule that is a functional group contributes to π-electron conjugate system and a spread of the π-electron conjugate system which is essential for electroconductivity is very small. Even if the number of thiophene molecules which are the above functional groups could be increased, it is difficult that the factors forming the orderliness of the film are coordinately and consistent with the intermolecular interaction between the long-chain alkyl part and the thiophene part.

As to the electroconductive characteristics, only one thiophene molecule which is a function group has a large HOMO-LUMO energy gap, giving rise to the problem that only insufficient carrier mobility is obtained even if a TFT is used in an organic semiconductor layer.

The present invention has been made in view of the above problem and has the following object. Specifically, it is an object of the present invention to provide a novel π-electron conjugate molecule-containing organic silicon compound which can be easily crystallized by a simple production method using a solution process to form a thin film, makes the obtained thin film adsorb to the surface of a substrate firmly to prevent the thin film from being peeled off physically and has high orderliness, crystallinity and electroconductivity, and to provide a method of producing the organic silicon compound. Another object of the present invention is to provide a compound which can secure sufficient carrier mobility when used as an electronic device such as a TFT and a method of producing the compound.

### Means of Solving the Problems

The inventors of the present invention have made earnest studies to attain the above object and, as a result, found that in order to produce a thin film applicable to electronic devices such as TFTs, it is necessary to use a compound which can form a two-dimensional network of Si—O—Si and bind with a substrate firmly and can form a thin film whose orderliness (crystallinity) can be controlled by interaction, namely, intermolecular force of the molecules (here, a π-electron conjugate molecule) formed on the two-dimensional network of Si—O—Si, and invent a novel π-electron conjugate molecule-containing organic silicon compound. The inventors of the present invention have also found that if a hydrophobic group is introduced into the molecular structure of the compound, the compound is improved in solubility in an organic solvent and a self-organizing film can be uniformly formed when the compound is used.

According to the present invention, there is provided a π-electron conjugate molecule-containing silicon compound represented by the formula (I): 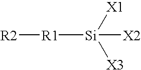
wherein R1 represents an organic group obtained by combining two or more units constituting plural π-electron conjugate systems, R2 represents a hydrophobic group and X1 to X3, which may be the same or different, respectively represent a group providing a hydroxyl group when it is hydrolyzed or a hydrogen atom.

According to the present invention, there is provided a π-electron conjugate molecule-containing silicon compound represented by the formula (II): 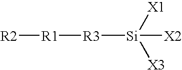
wherein R1, R2 and X1 to X3 are as defined above, R3 represents a hydrophobic group.

According to the present invention, there is provided a method of producing a π-electron conjugate molecule-containing silicon compound comprising reacting a compound represented by the formula (III) or (IV):
R2-R1-R3-Z (III)
R2-R1-R3-Z (IV)
wherein R1 to R3 are as defined above and Z represents MgX, wherein X represents a halogen atom or Li, with a compound represented by the formula (V): 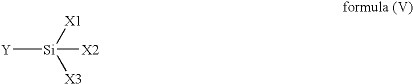
wherein X1 to X3 are as defined above and Y represents a hydrogen atom, a halogen atom or a lower alkoxy group

to produce the π-electron conjugate molecule-containing silicon compound represented by the formula (I) or (II): 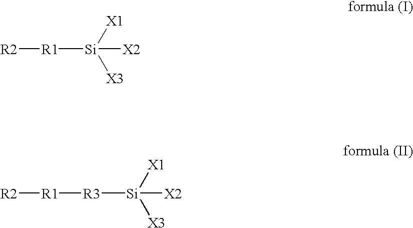
wherein R1 to R3 and X1 to X3 are as defined above.

### EFFECT OF THE INVENTION

The organic silicon compound of the present invention has a hydrophobic group and therefore has high solubility in a nonaqueous type solvent. In the case of, for example, forming a thin film, a solution process which is a relatively simple method can be applied to this organic silicon compound.

Also, the organic silicon compound of the present invention forms a two-dimensional network of Si—O—Si formed between organic silicon compounds having a π-electron conjugate molecule whereby it is chemically adsorbed to a substrate and the intermolecular interaction among π-electron conjugate molecules which is the short range force necessary for the crystallization of a film is exerted efficiently. Therefore, a thin film which has very high stability and is highly crystallized can be constituted. Therefore, the resulting film can be adsorbed to the surface of the substrate more firmly than a film formed on a substrate by physical adsorption and can be therefore prevented from being peeled off physically. Also, the compound as mentioned above can be produced simply.

Also, the network derived from the organic silicon compound constituting the thin film is directly connected with an organic residue constituting the upper part and a thin film having high orderliness (crystallinity) can be formed by the network derived from the organic silicon compound and the intermolecular interaction of the π-electron conjugate molecules. This ensures that carriers are transferred smoothly by hopping conduction in a direction perpendicular to the plane of a molecule. Also, because high electroconductivity is obtained in the direction of the axis of a molecule, the organic silicon compound may be widely applied not only to organic thin film transistor materials but also to devices such as solar cells, fuel cells and sensors as a conductive material.

### BRIEF DESCRIPTION OF DRAWINGS

FIG. 1 is a view for explaining the relationship between intermolecular distance and intermolecular force.

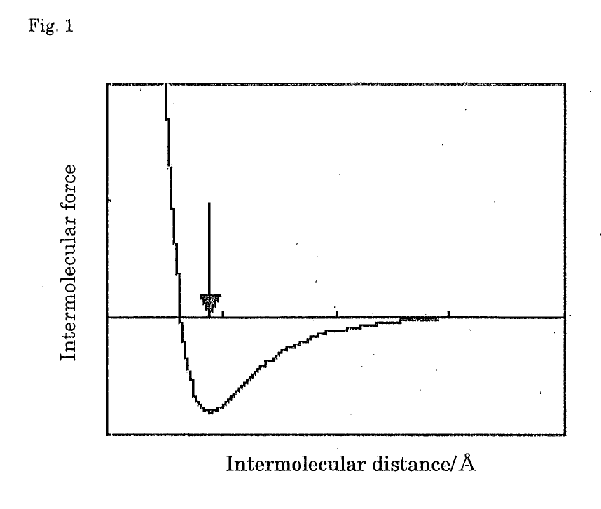

### BEST MODE FOR CARRYING OUT THE INVENTION

The π-electron conjugate molecule-containing silicon compound of the present invention is represented by the formula (I) or (II): 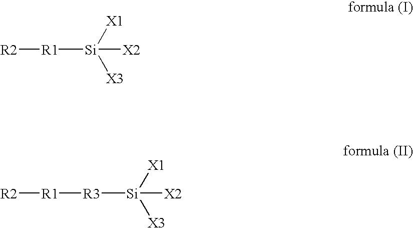
wherein R1 represents an organic group obtained by combining two or more units constituting plural π-electron conjugate systems, R2 represents a hydrophobic group, R3 represents a hydrophobic group and X1 to X3, which may be the same or different, respectively represent a group providing a hydroxyl group when it is hydrolyzed or a hydrogen atom.

Generally, many molecules in which a π-electron conjugate system is spread are sparingly soluble even in organic solvents. On the contrary, the compound of the present invention is improved in solubility in an organic solvent by the existence of the hydrophobic groups R2 and R3 as shown in the above formulae (I) and (II) and may be therefore applied to a solution process.

Explanations will be furnished as to each structure of the formulae (I) and (II).

First, R1 represents an organic group obtained by combining two or more units constituting plural π-electron conjugate systems. Generally, a conjugate double bond has one bond of a π-electron and one bond of a π-electron and therefore, the term “unit constituting a π-electron conjugate system” means a compound having at least one conjugate double bond. Specifically, this unit may be selected from the group consisting of groups derived from aromatic hydrocarbons, condensed polycyclic hydrocarbons, monocyclic heterocyclic compounds, condensed heterocyclic compounds, alkenes, alkadienes and alkatrienes.

Examples of the aromatic hydrocarbons include benzene, toluene, xylene, mesitylene, cumene, cymene, styrene and divinylbenzene. Among these compounds, benzene is preferable.

Examples of the condensed polycyclic hydrocarbons include indene, naphthalene, azulene, fluorene, phenanthrene, anthracene, acenaphthylene, biphenylene, naphthacene, pyrene, pentalene and phenalene.

Examples of the monocyclic heterocyclic compounds include furan, thiophene, pyrrole, oxazole, isoxazole, thiazole, isothiazole, pyridine, pyrimidine, pyrroline, imidazoline and pyrazoline. Particularly, compounds containing one or more sulfur atoms are preferable. Among these compounds, thiophene is particularly preferable.

Examples of the condensed heterocyclic compounds include indole, isoindole, benzofuran, benzothiophene, indolizine, chromene, quinoline, isoquinoline, purine, indazole, quinazoline, cinnoline, quinoxaline and phthalazine.

Examples of the alkadienes include compounds having 4 to 6 carbon atoms, ex. butadiene, pentadiene and hexadiene.

Examples of the alkatrienes include compounds having 6 to 8 carbon atoms, ex. hexatriene, heptatriene and octatriene.

The group derived from the above examples, that is, the unit may be combined in the plural, wherein these units may be combined in a linear state and/or in a branched state. It is preferable that these units may be combined linearly. These units are preferably used in combinations of 3 to 10 units in consideration of yield and in combinations of 3 to 8 units in consideration of economical efficiency and mass-production efficiency. Also, in these units, the same groups may be combined, groups which are all different from each other may be combined or plural types of groups may be combined regularly or at random.

Also, when the unit is a group made of a five-membered ring, the binding positions may be any of 2,5-positions, 3,4-positions, 2,3-positions and 2,4-positions. Among these positions, 2,5-positions are preferable. In the case of six-membered ring, the binding positions may be any of 1,4-positions, 1,2-positions and 1,3-positions. Among these combinations, 1,4-positions are preferable. Specific examples of this five- or six-membered ring unit include groups derived from biphenyl (a), SC₅H₅—C₅H₅S(b), bithienyl (c), terphenyl (d), terthienyl (e), quaterphenyl (f), quaterthiophene (g), quinterphenyl (h), quinterthiophene (i), sexiterphenyl (j), sexiterthiophene (k), thienyl-oligophenylene (l), phenyl-oligothienylene (m) and phenylene-thienylene block oligomer (n). Examples of the structural formulae of these specific examples (a) to (n) will be described below. In the above units, a and b respectively denote an integer of 2 or more, d and e respectively denote an integer of 1 or more and c and f respectively denote an integer of 0 or more (not 0 at the same time).

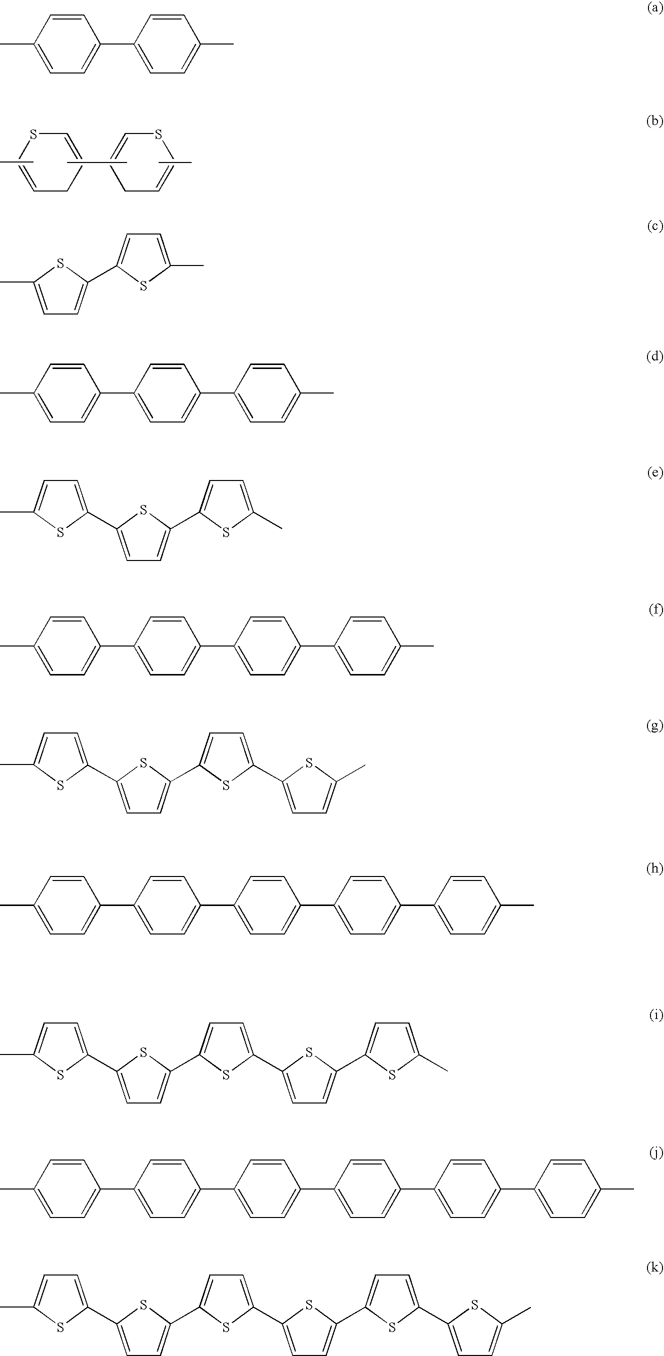

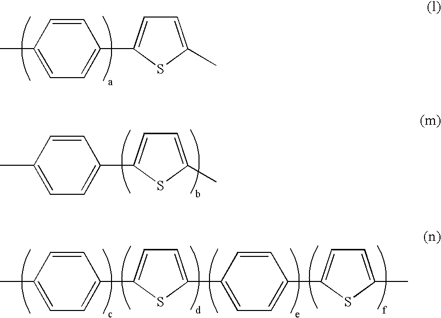

The unit may have a group derived from a compound, such as ethylene and butadiene, containing one or two or more conjugate double bonds between neighboring five-membered ring and six-membered ring.

Specific examples of R2 include an alkyl group, oxyalkyl group, fluoroalkyl group and fluorine atom. These groups are preferably combined linearly though they may be combined in a branched state. When, particularly, the compound of the present invention is used as a film-forming material, a straight-chain hydrocarbon having 1 to 30 and preferably 2 to 18 carbon atoms is preferable.

Also, the hydrophobic group R2 may be combined with any part of a π-electron conjugate molecule and also, there is no particular limitation to the number of the introduced hydrophobic groups insofar as the number is 1 or more. When the number of the introduced hydrophobic groups is plural, these hydrophobic groups may be the same or different.

The compound of the present invention contains a silanol derivative represented by SiX1X2X3 at its terminal. Here, X1, X2 and X3 are groups respectively providing a hydroxyl group when the compound is hydrolyzed. There is no particular limitation to the groups and, for example, a halogen atom and a lower alkoxy group are given as examples. Examples of the halogen atom include a fluorine atom, chlorine atom, iodine atom and bromine atom. Examples of the lower alkoxy group include alkoxy groups having 1 to 4 carbon atoms. Examples of these alkoxy groups include a methoxy group, ethoxy group, n-propoxy group, 2-propoxy group, n-butoxy group, sec-butoxy group and tert-butoxy group. Also, a part of the above alkoxy group may be further substituted with other functional groups (for example, trialkylsilyl groups and other alkoxy groups).

X1, X2 and X3 may be the same or different or two of them may be the same and the other one may be different. They are preferably the same.

Also, the compound of the present invention may have a hydrophobic group R3 between the π-electron cojugate molecule and a silanol group. As this hydrophobic group R3, the same groups as those exemplified as R2 may be used.

The compound of the present invention is preferably those having R1: an organic group in which 2 to 6 thienylene groups are linearly combined at 2,5-positions, organic group in which 2 to 6 phenylene groups are linearly combined at 1,4-positions or organic group in which one or more thienylene groups having bonds at 2,5-positions and one or more phenylene groups having connectors at 1,4-positions, wherein the sum of the both groups is 6 or less, the thienylene group and/or the phenylene group may have substituents selected from C1-8 alkyl groups or phenylene groups substituted optionally with halogen atoms and a vinylene group may be contained between the thienylene group and/or the phenylene group;

R2 and R3: an alkyl group having 1 to 18 carbon atoms; and

X1 to X3: a halogen atom or an alkoxy group having 1 to 4 carbon atoms.

Compounds A to M that are preferable as the compound of the present invention will be described below.

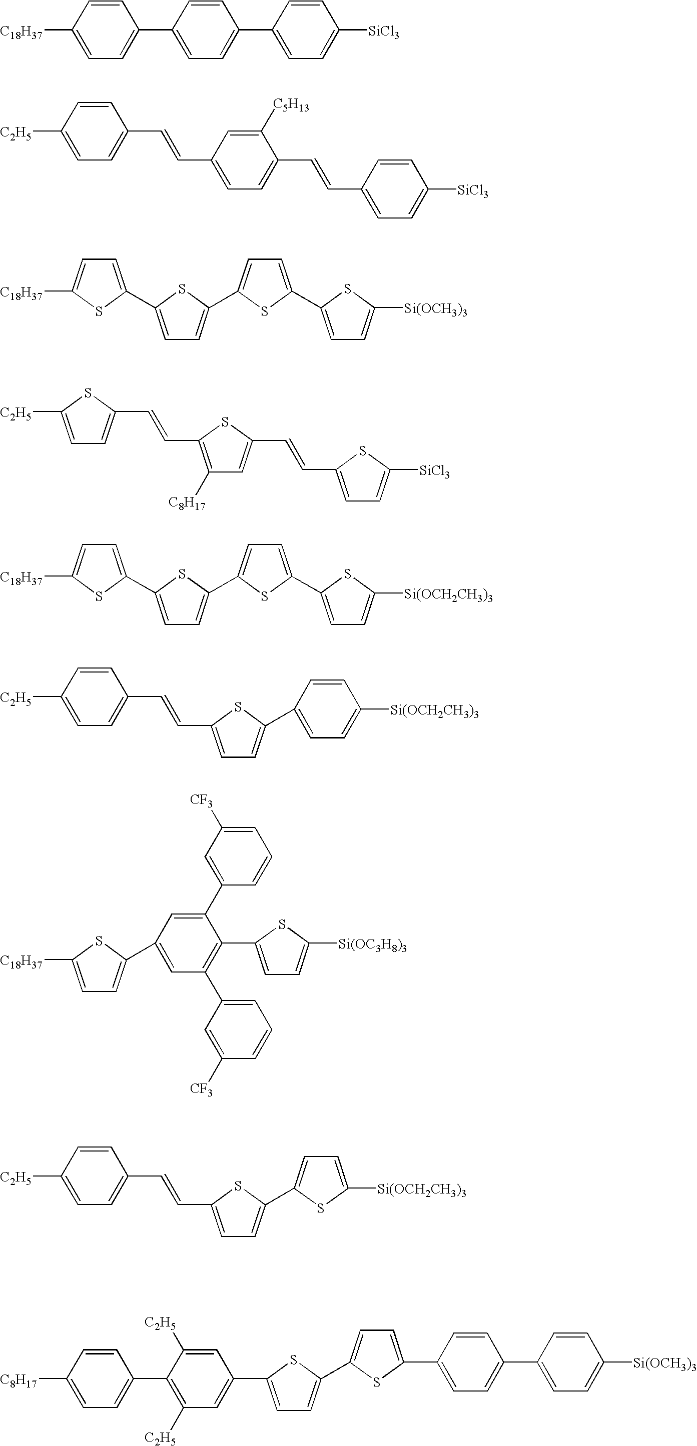

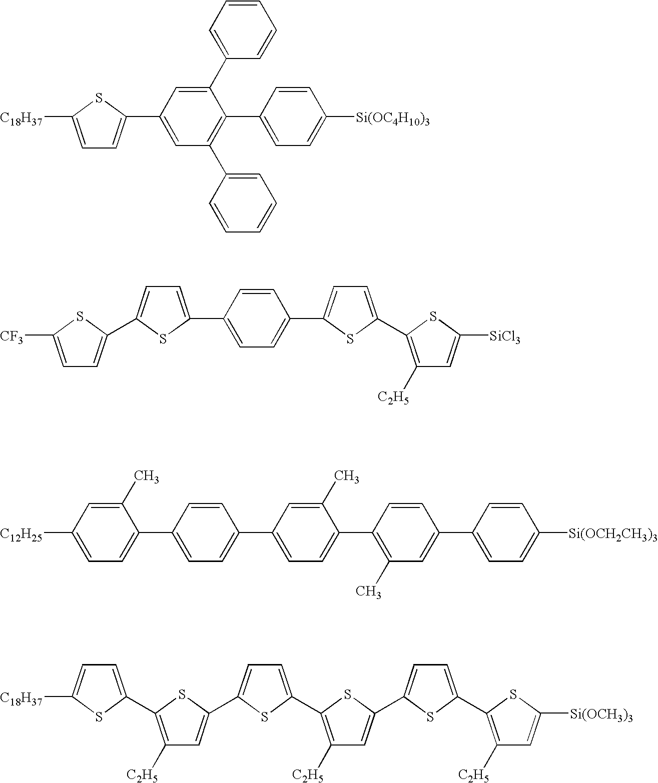

The compound of the present invention may be produced by a Grignard reaction or lithium dissociation reaction between a Grignard's reagent or a lithium compound produced from a π-electron conjugate molecule and a silanol derivative. Specifically, the π-electron conjugate molecular-containing silicone compound represented by the formula (I) or (II) may be produced by reacting a compound represented by the formula (III) or (IV):
R2-R1-Z (III)
R2-R1-R3-Z (IV)
wherein R1 to R3 are as defined above and Z represents MgX (where X represents a halogen atom) or lithium), with a compound represented by the formula (V): 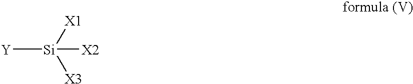
wherein X1, X2 and X3, which may be the same or different, respectively represent a group providing a hydroxyl group when the compound is hydrolyzed and Y represents a hydrogen atom, a halogen atom or a lower alkoxy group. In this production method, examples of the halogen atom include a fluorine atom, chlorine atom and bromine atom and examples of the lower alkoxy group include a methoxy group, ethoxy group and propoxy group.

The temperature in the Grignard reaction or lithium dissociation reaction is, for example, −100 to 150° C. and preferably −20 to 100° C. The reaction time is, for example, about 0.1 to 48 hours. The reaction is usually run in an organic solvent having no influence on the reaction. Examples of the organic solvent having no influence on the reaction include hydrocarbons such as hexane, pentane, benzene and toluene, ether type solvents such as diethyl ether, dipropyl ether, dioxane and tetrahydrofuran (THF) and aromatic hydrocarbons such as benzene and toluene. These organic solvents may be used either singly or as a mixture solution. Among these solvents, diethyl ether and THF are preferable. In the reaction, a catalyst may be optionally used. As the catalyst, a known catalyst such as a platinum catalyst, palladium catalyst or nickel catalyst may be used.

The method of synthesizing a silicon compound according to the present invention will be explained. The reaction temperature and the reaction time in the following synthetic methods are the same as those mentioned above and are, for example, −100 to 150° C. and 0.1 to 48 hours.

The following explanations are furnished as to a synthetic example of a precursor of the organic group (R1) constituted of a unit derived from benzene which is an example of the monocyclic aromatic hydrocarbon and a unit derived from thiophene which is an example of the monocyclic heterocycle compound. A precursor of heterocyclic compounds containing a nitrogen atom or an oxygen atom may also be produced in the same manner as in the production of a sulfur-containing heterocyclic compound such as thiophene.

As a method of synthesizing the precursor constituted of a unit derived from benzene or thiophene, a method in which, first, the reaction part of benzene or thiophene is halogenated and then, a Grignard reaction is utilized is effective. The use of this method makes it possible to synthesize a precursor in which the number of benzenes or thiophenes is controlled. Besides the method in which a Grignard's reagent is used, the precursor may be synthesized by coupling utilizing a proper metal catalyst (Cu, Al, Zn, Zr or Sn, etc.).

As to thiophene, the following synthetic methods may be utilized, as well as the method to which a Grignard's reagent is applied.

Specifically, first, the 2′-position or 5′-position of thiophene is halogenated (for example, chlorinated). Examples of the halogenating method include one-equivalent N-chlorosuccinimide (NCS) treatment and phosphorous oxychloride (POCl₃) treatment. As the solvent at this time, for example, a chloroform/acetic acid (AcOH) mixture solution or DMF may be used. Also, halogenated thiophenes are reacted among them under the presence of tris(triphenylphosphine)nickel (PPh)₃Ni as a catalyst in a DMF solvent, whereby these thiophenes can be combined at the halogenated parts resultantly.

Moreover, divinylsulfone is added to the halogenated thiophene to couple the both, thereby forming a 1,4-diketone body. In succession, a Lawesson Reagent (LR) or P₄S₁₀ is added to the 1,4-diketone body and the resulting mixture is refluxed overnight in the former case or for 3 hours in the latter case to cause a ring-closing reaction. As a result, a precursor having the number of thiophenes larger by one than the total number of the coupled thiophenes can be synthesized.

The number of thiophene rings can be increased by utilizing the above reaction of thiophene.

The above precursor may be halogenated at its terminal in the same manner as in the case of the raw material used for the synthesis. Therefore, the precursor is halogenated and then, reacted with, for example, SiCl₄ to obtain a silicon compound (simple benzene or simple thiophene compound) which has a silyl group at its terminal and is provided with an organic group (R1) constituted only of a unit derived from benzene or thiophene.

One example of a method of synthesizing the precursor of the organic group constituted only of benzene or thiophene and one example of a method of silylating the precursor are shown in the following (A) to (D). In this case, in the synthetic example of the precursor constituted only of thiophene, only reactions of thiophene trimers into hexamers or heptamers are shown. However, if this thiophene is reacted with a thiophene having different unit number, precursors other than the above hexamers or heptamers can be formed. For example, if 2-chlorobithiophene chlorinated by NCS after 2-chlorothiophene is coupled is reacted in the same manner as in the following method, a thiophene tetramer or pentamer can be formed. Moreover, if the thiophene tetramer is chlorinated by NCS, a thiophene octamer or nonamer can also be formed.

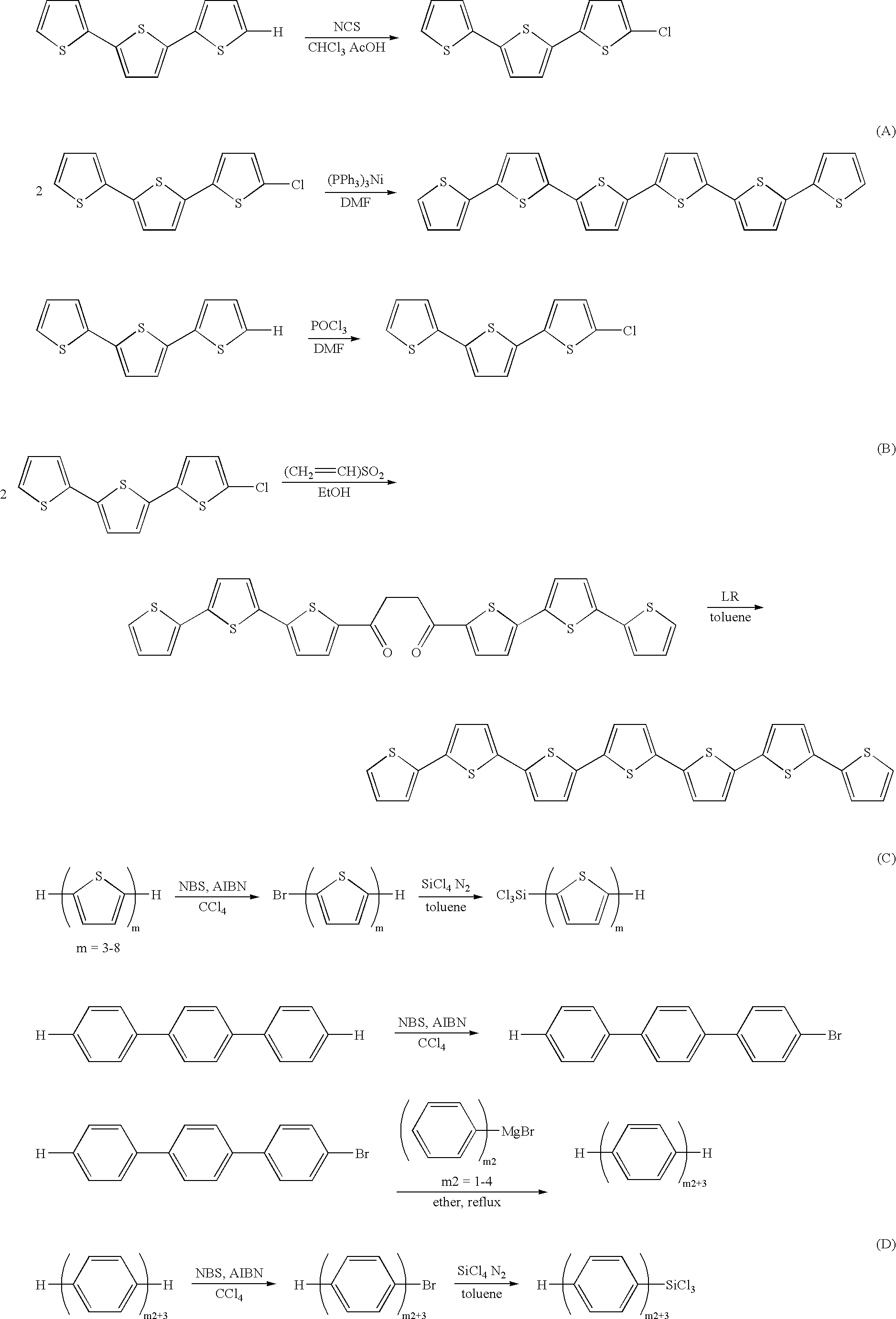

There is, for example, a method using a Grignard reaction as a method used to obtain a block type organic group precursor by directly binding units obtained by binding units derived from a specified number of thiophenes or benzenes. If the precursor is reacted with SiCl₄ or HSi(OEt)₃, a target silicon compound can be obtained. Also, among the above compounds, the compound having a terminal alkoxy group and a silyl group can be synthesized in the condition that it is bound with the raw material in advance because it has low reactivity. As synthetic examples in this case, the following method may be applied.

First, an opposite terminal of a silyl group of a simple benzene or simple thiophene compound is halogenated (for example, brominated) and then, the functional group combined with the silyl group is converted from the halogen into an alkoxy group by a Grignard reaction. In succession, n-BuLi and B(O-iPr)₃ are added to carry out debromination and the formation a boron compound. The solvent used at this time is preferably an ether. Also, the reaction when the boron compound is formed is preferably run in two stages: the reaction is run at −78° C. in the first stage to stabilize the reaction in the initial stage and at temperatures raised gradually from −78° C. to ambient temperature in the second stage. In the meantime, an intermediate of a block type compound is produced by a Grignard reaction using benzene or thiophene having halogen groups (for example, a bromo group) at both terminals.

In this state, if the intermediate having unreacted bromo group and the above boron compound are placed in, for example, a toluene solvent and are reacted completely at a reaction temperature of 85° C. in the presence of Pd(PPh₃)₄ and Na₂CO₃, it is possible to cause coupling. As a result, a silicon compound having a silyl group at the terminal of a block type compound can be synthesized.

One example of the synthetic routes of silicon compounds (E) and (F) by using such a reaction is shown below. Here, the compound having a halogen group (for example, a bromo group) and a trichlorosilyl group at both terminals of the unit derived from benzene or thiophene may be formed by reacting p-phenylene or 2,5-thiophenediyl with a halogenating agent (for example, NBS) to halogenate both terminals and then by reacting the reaction product with SiCl₄ to substitute one of the terminal halogen with a trichlorosilyl group.

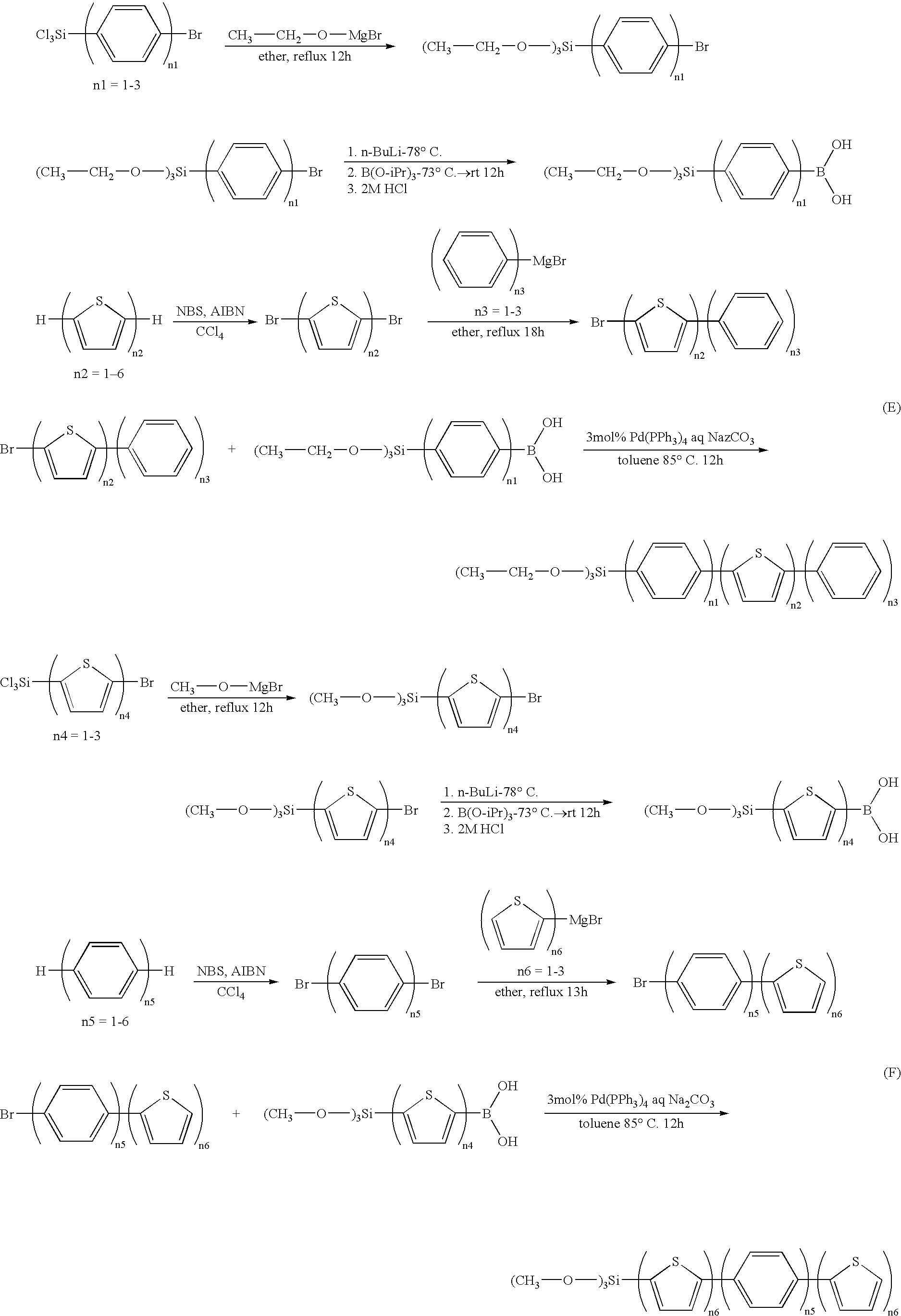

As a method of synthesizing a precursor in which units derived from benzene or thiophene and vinyl groups are alternately bound, for example, the following method may be applied. Specifically, a raw material made of benzene or thiophene provided with a methyl group at its reaction position is prepared and then, its both terminals are brominated by using 2,2′-azobisisobutyronitrile (AIBN) and N-bromosuccinimide (NBS). Thereafter, PO(OEt)₃ is reacted with the bromo body to form an intermediate. In succession, a compound having an aldehyde group at its terminal is reacted with the intermediate in, for example, a DMF solvent by using NaH, whereby the above precursor can be formed. The resulting precursor has a methyl group at its terminal. Therefore, if the methyl group is further brominated and the above synthetic route is applied again, a precursor more increased in the number of units can be formed.

If the obtained precursor is brominated using, for example, NBS, the brominated part can be reacted with SiCl₄. Therefore, a silicon compound having SiCl₃ at its terminal can be formed. One example of the synthetic routes of precursors (G) to (I) differing in length and silicon compound (J) is shown below by the above reaction.

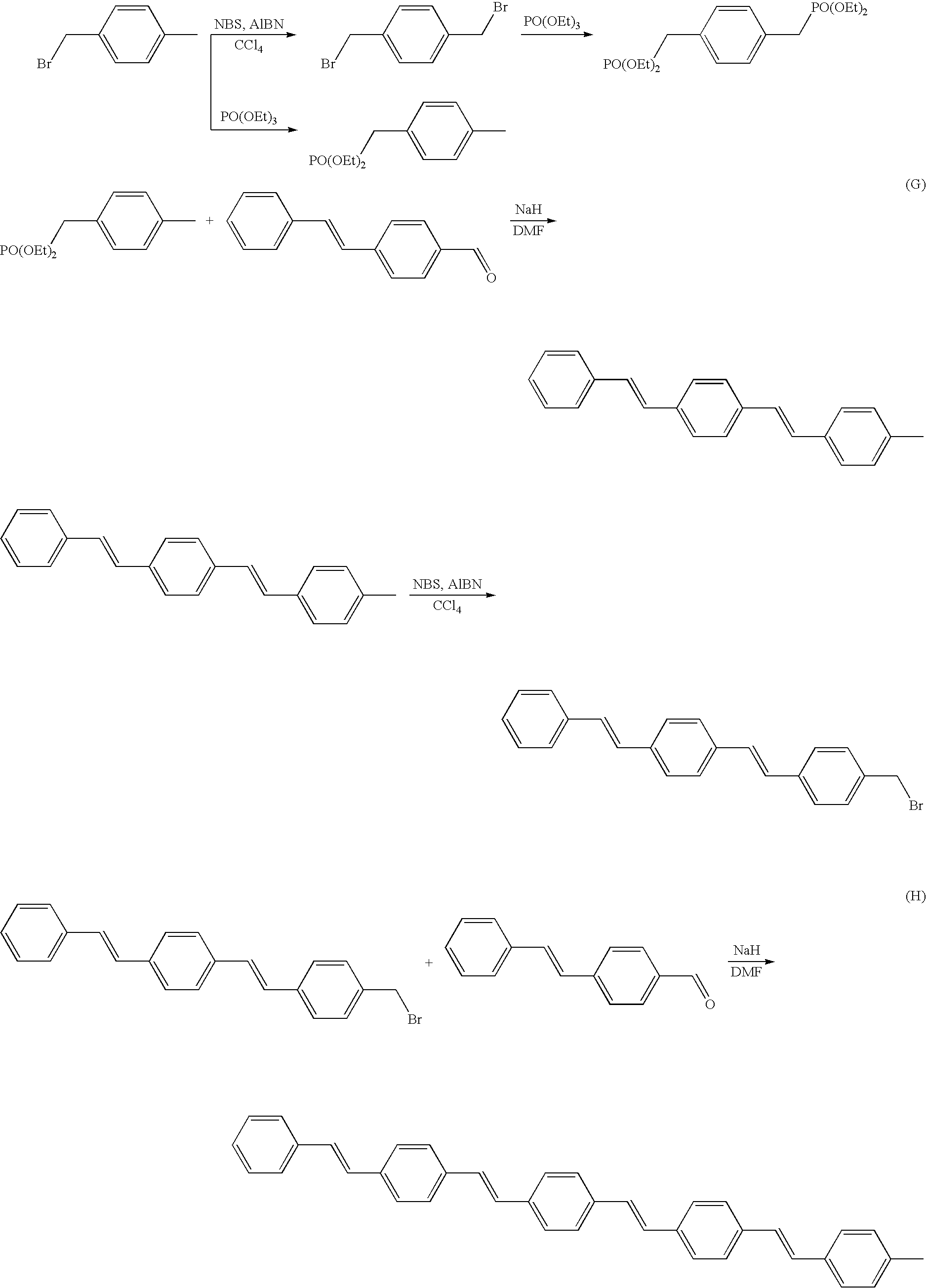

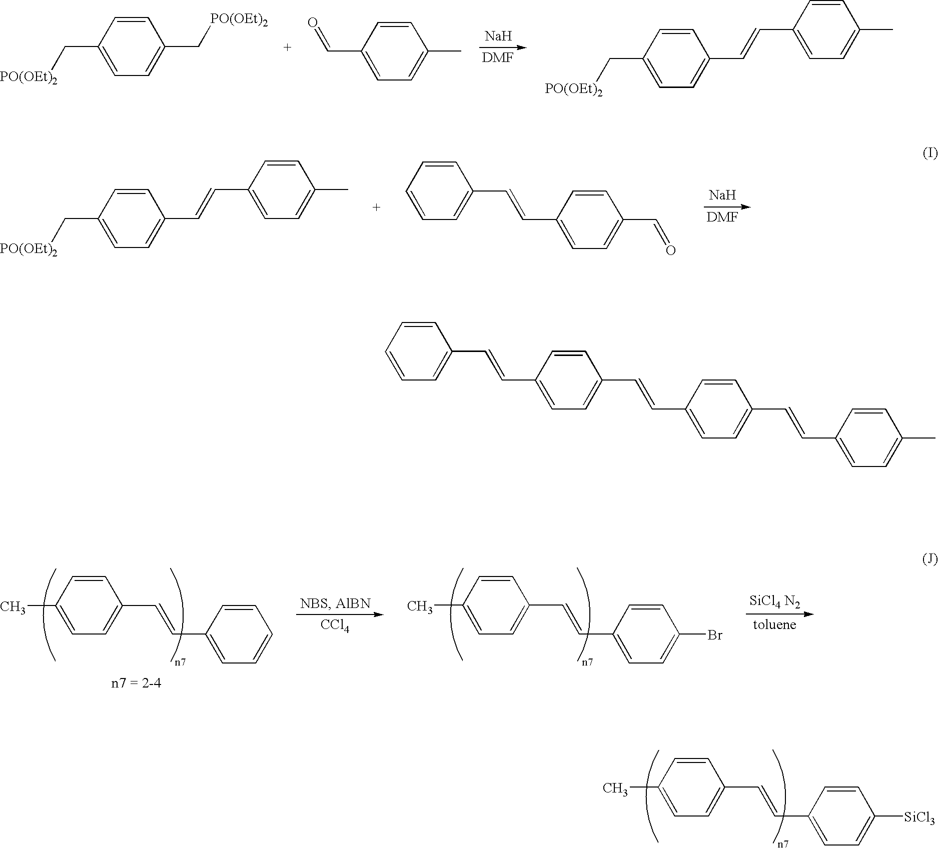

Any of these compounds may use a raw material having a side chain (for example, an alkyl group) at a specified position. Specifically, if for example, 2-octadecylterthiophene is used as a raw material, 2-octadecylsexithiophene can be obtained as the precursor (A) by the above synthetic route. Therefore, 2-octadecylsexithiophenetrichlorosilane can be obtained as the silane compound (C). Similarly, any of the above compounds (A) to (J) having a side chain can be obtained if a raw material having a side chain at a specified position is used.

Next, a method of introducing a side chain (hydrophobic group: R2) will be explained. In the case where, like the compound of the present invention, a compound has a highly reactive functional group at its terminal, it is preferable to introduce the side chain into the raw material or the intermediate as mentioned above or to introduce the side chain after the side chain is converted into a silyl group having a alkoxy group having relatively low reactivity. As the side chain to be introduced, an alkyl chain is preferable in the case of intending primarily to improve the solubility. As to the introduction method, a coupling reaction using a metal catalyst including a Grignard reaction may be applied after the position into which an organic group is to be introduced is halogenated. As one example, a method of synthesizing π-electron conjugate molecule-containing silicon compound of the present invention in the case where the side chain is an alkyl chain will be shown below.

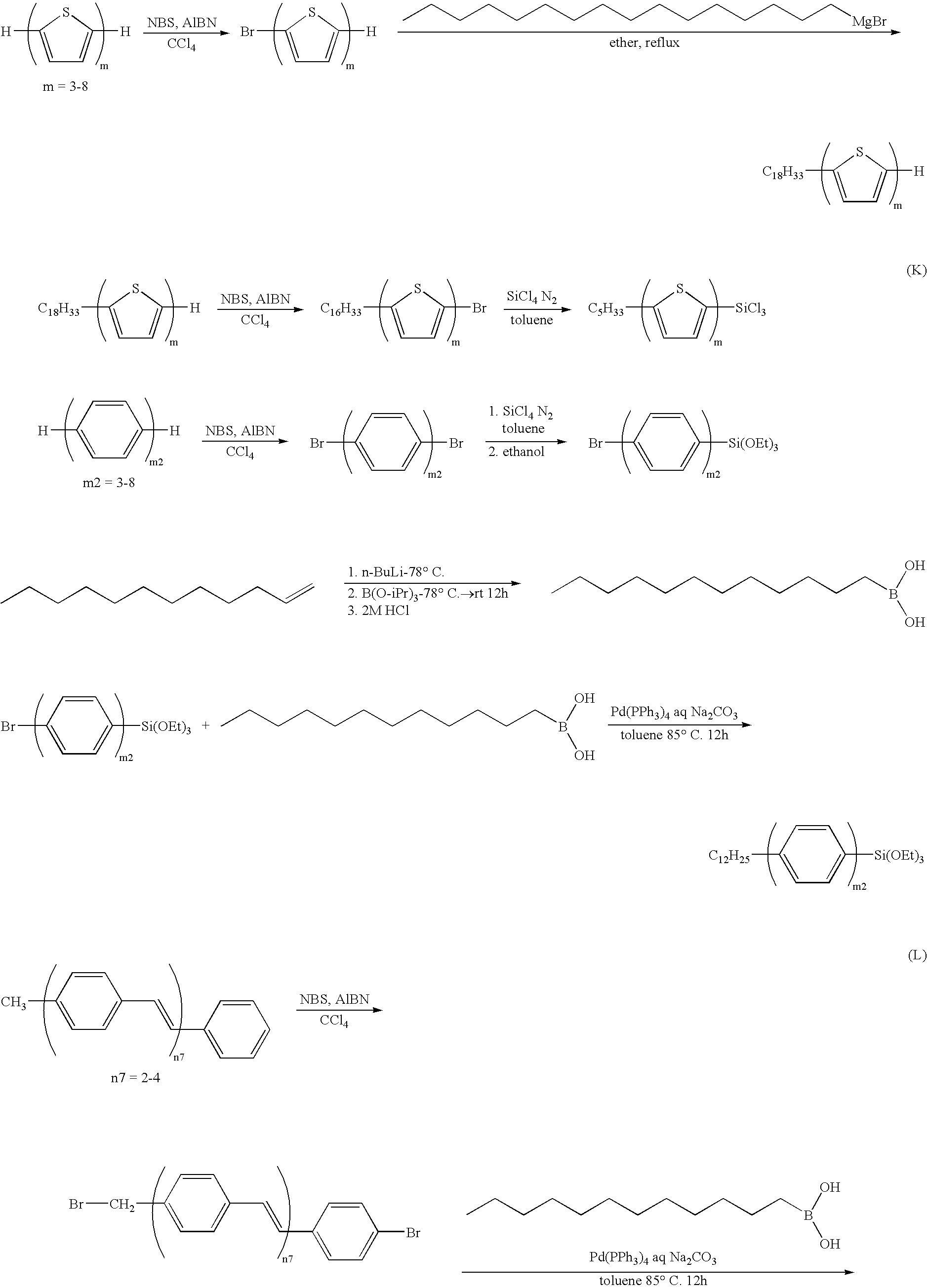

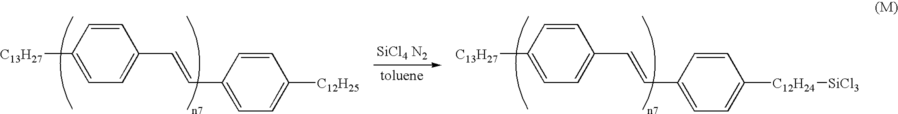

In the above synthetic method, only the case where the side chain is an alkyl chain is shown. However, an alkoxy group may be introduced using the same method.

Also, the raw material used in the above synthetic example is a common reagent, which is commercially available from a reagent maker and can be utilized. The CAS number and the purity of a reagent in the case where the reagent maker is Kishida Kagaku are shown below.

TABLE 1

| Raw material | CAS No. | Purity |
|---|---|---|
| 2-chlorothiophene | 96-43-5 | 98% |
| 2,2′,5′,2″-terthiophene | 1081-34-1 | 99% |
| Bromobenzene | 108-86-1 | 98% |
| 1,4-dibromobenzene | 106-37-6 | 97% |
| 4-bromobiphenyl | 92-66-0 | 99% |
| 4,4′-dibromobiphenyl | 93-86-4 | 99% |
| p-terphenyl | 92-94-4 | 99% |
| α-bromo-p-xylene | 104-81-4 | 98% |

The compounds (I) and (II) obtained in this manner may be isolated from the reaction solution and purified by known measures such as trans-dissolution, concentration, solvent extraction, fractionation, crystallization, recrystallization and chromatography.

The compound of the present invention may be formed into a thin film in the following manner. First, the compound of the present invention is dissolved in a nonaqueous type organic solvent such as hexane, chloroform or carbon tetrachloride. A base body (preferably a base body having active hydrogen such as a hydroxyl group or carboxyl group) on which a thin film is to be formed is dipped in the obtained solution and then pulled up. Or, the obtained solution may be applied to the surface of the base body by utilizing a coating method such as a spin coating method or ink jet method. After that, the base body is washed with a nonaqueous organic solvent and then with water, and allowed to stand or heated to dry the base body to fix the thin film. This thin film may be used directly as electric materials or may be further subjected to treatment such as electrolytic polymerization. The compound of the present invention can be formed as a self-organized thin film (for example, a monomolecular film) with ease.

The compound of the present invention has a network structure constituted from a silicon atom and an oxygen atom, is reduced in the distance between neighboring π-electron conjugate molecules and is highly crystallized. Also, when the unit is arranged linearly, the distance between neighboring π-electron conjugate molecules is smaller, making it possible to obtain a material capable of forming a highly crystallized organic thin film.

If, at this time, the hydrophobic group R3 exists between then electron conjugate molecule and a silanol group, the film is packed more highly densely by the hydrophobic interaction at this part. This is significantly exhibited when R3 is a straight-chain hydrocarbon group.

### EXAMPLES

Synthetic examples of the π-electron conjugate molecule-containing compound of the present invention will be described. Hereinafter, a straight-chain alkyl unit is represented by the number of carbon atoms. For example, an octadecyl group is shown as C18. Also, a phenylene unit and a thiophene unit are represented by P and Th respectively and the numerals behind the symbols show the numbers of phenylene units and thiophene units which are bound linearly. For example, a terthiophene molecule is noted by Th3.

### Synthetic Example 1

### Synthesis of C18-P3 using 1-octadecane and terphenyl and synthesis of C18-P3-SiCl₃ using C18-P3 and tetrachlorosilane

C18-P3 was synthesized by the following method.

First, a specified amount of 1-octadecane was reacted with an equivalent amount of butyl lithium in THF to add lithium to octadecane. In succession, the lithium-addition 1-octadecane was reacted with 1-bromo-phenyl in THF to synthesize C18-P3.

Moreover, C18-P3 was brominated and reacted with SiCl₄ to synthesize the following C18-P3-SiCl₃ (yield 45%).

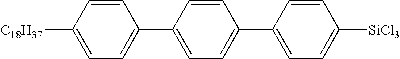

The obtained compound was subjected to measurement of infrared absorption spectrum and as a result, absorption originated from SiC was observed at 1062 cm⁻¹, to confirm that the compound had a SiC bond. Also, the ultraviolet-visible absorption spectrum of the solution containing the compound was measured and as a result, absorption was observed at a wavelength of 280 nm. This absorption is caused π→π* transition of a terphenyl molecule contained in the molecule, and it was therefore confirmed that the compound contained a terphenyl molecule.

Moreover, the compound was subjected to measurement of nuclear magnetic resonance (NMR). In this case, because this compound had high reactivity, it is difficult to carry out NMR measurement directly. Therefore, the NMR was measured after the compound was reacted with ethanol (at this time, the generation of hydrogen chloride was confirmed) to exchange the terminal chlorine for an ethoxy group. As a result, the following peaks were obtained.

7.90 ppm to 7.25 ppm (m) (originated from a 12H aromatic)

2.60 ppm to 2.5 ppm (m) (originated from a 6H ethoxy group-ethyl group)

1.40 ppm to 1.3 ppm (m) (originated from a 9H ethoxy group-methyl group, 37H methylene and methyl group)

From these results, this compound was confirmed to be C18-P3-SiCl₃.

Also, the obtained compound had a solubility about 2.8 times that of P3-SiCl₃ (solubility: about 2.0 mg/ml) in 1 ml of THF, showing that it exhibited high solubility in an organic solvent.

### Synthetic Example 2

Synthesis of C18-Th4 using 1-octadecane and quaterthiophene and synthesis of C18-Th4-Si(OCH₃)₃ using C18-Th4 and tetramethoxysilane

Further, C18-Th4 was brominated and then reacted with tetramethoxysilane to synthesize the following C18-Th4-Si(OCH₃)₃.

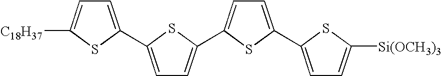

The obtained compound was subjected to measurements of infrared absorption spectrum, ultraviolet-visible absorption spectrum and NMR as Example 1, to confirm that this compound was C18-Th4-Si(OCH₃)₃.

Also, the obtained compound had a solubility about 9.5 times that of Th4-SiCl₃ (solubility: about 1.0 mg/ml) in 1 ml of toluene, showing that it exhibited high solubility in an organic solvent.

### Synthetic Example 3

Synthesis of C18-Th4 using 1-octadecane and quaterthiophene and synthesis of C18-Th4-Si(OC₂H₅)₃ using C18-Th4 and tetraethoxysilane

C18-Th4 was synthesized in the same method as in Example 2. In succession, the thiophene part of C18-Th4 was brominated and then reacted with tetraethoxysilane to synthesize the following C18-Th4-Si(OC₂H₅)₃.

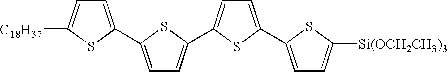

The obtained compound was subjected to measurements of infrared absorption spectrum, ultraviolet-visible absorption spectrum and NMR as Example 1, to confirm that this compound was C18-Th4-Si(OC₂H₅)₃.

Also, the obtained compound had a solubility about 10 times that of Th4-SiCl₃ (solubility: about 1.0 mg/ml) in 1 ml of toluene, showing that it exhibited high solubility in an organic solvent.

### Synthetic Examples 4 to 13

In the above Synthetic Examples 1 to 3, only the methods of synthesizing C18-P3-SiCl₃, C18-Th4-Si(OCH₃)₃ and C18-Th4-Si(OC₂H₅)₃ are shown. However, organic silicon compounds having the above structural formulae D to M binded silicon directly with an alkyl (or an alkoxy) group and an aromatic group can be synthesized in the same method as in above synthetic Examples 1 to 3.

Examples of the organic solvent that can dissolve the organic silane compound of the present invention include, besides THF and toluene used in the above Synthetic Examples, nonaqueous organic solvents such as hexane, n-hexadecane, methanol, ethanol, IPA, chloroform, dichloromethane, carbon tetrachloride, 1,1-dichloroethane, 1,2-dichloroethane, dimethyl ether, diethyl ether, DMSO, xylene and benzene, though different depending on functional groups and silyl group contained in the compound.

All the compounds obtained in the above Synthetic Examples 1 to 13 have the characteristics that each has higher solubility than compounds having no hydrophobic group and high generality in the formation of a film utilizing, for example, a solution system.

The π-electron conjugate molecule-containing silicon compound contains a hydrophobic group at its side chain and therefore has the advantage that it is improved in solubility in a hydrophobic organic solvent. Therefore, even a material increased in the number of π-electron conjugate units, which material is not conventionally used in a solution process, can be applied and it is therefore possible to provide a functional organic thin film having higher conductivity.

Particularly, when the hydrophobic group, the π-electron conjugate molecule and the silanol derivative part are bound in series, the steric hindrance of the structural molecules is very reduced, so that a highly oriented organic thin film having a small intermolecular distance can be provided.

Also, the π-electron conjugate molecule in the present invention is an amphipatic molecule having both hydrophobic and hydrophilic molecules. Emulsion particles can be obtained by dispersing the n-electron conjugate molecule in, for example, an organic solvent. Since the particle contains the π-electron conjugate molecule and therefore has conductivity. This particle can be combined with a silanol group by allowing the solvent to contain water in advance and it is possible to encapsulate emulsion particles according to the need. The π-electron conjugate molecule of the present invention may be applied to the capsulation technologies.

### Example 3

An example in which the compound of the present invention is used to form a functional organic thin film is described.

Using C18-Th4-Si(OC₂H₅)₃ obtained in Synthetic Example 3, a functional thin film was formed in the following manner.

First, a quartz substrate was dipped in a mixed solution of hydrogen peroxide and concentrated sulfuric acid (mixing ratio: 3:7) for one hour to carry out hydrophilic treatment of the surface of the quartz substrate. After that, C18-Th4-Si(OC₂H₅)₃ was dissolved in a nonaqueous organic solvent (for example THF) to obtain a 10 mM C18-Th4-Si(OC₂H₅)₃ solution. The obtained substrate was dipped in this solution in an inert atmosphere for 30 minutes. Then, the substrate was pulled up slowly and then washed with a solvent to form a film on the quarts substrate.

The quartz substrate on which a film was formed was subjected to measurement of ultraviolet-visible absorption spectrum and to measurement of a film thickness using ellipsometry. It was confirmed from these results that a monomolecular film containing C18-Th4-Si(OC₂H₅)₃ was formed on the quartz substrate.

Also, when the formed monomolecular film was subjected to a SPM device to observe its surface, a periodic structure was observed. When this monomolecular film having a periodic structure was subjected to a scratch strength test using the cantilever of the SPM device, it was confirmed that the stress of the cantilever necessary to disturb the periodic structure of the monomolecular film (C18-Th4-Si(OC₂H₅)₃ thin film) was 1.2 times that of Th4-Si(OC₂H₅)₃. This reason is considered to be that the addition of a straight-chain hydrocarbon group as the side chain increases the molecular interaction with neighboring molecules when the monomolecular film is formed. Therefore, the use of the compound of the present invention made it possible to form an organic thin film which had strong durability and was closely packed by the strong interaction between molecules.

1. A π-electron conjugate molecule-containing silicon compound represented by the formula (I): 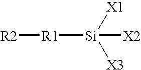
wherein R1 represents an organic group obtained by combining two or more units constituting plural π-electron conjugate systems, R2 represents a hydrophobic group and X1 to X3, which may be the same or different, respectively represent a group providing a hydroxyl group when it is hydrolyzed or a hydrogen atom.

2. A π-electron conjugate molecule-containing silicon compound represented by the formula (II): 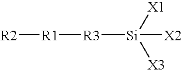
wherein R1, R2 and X1 to X3 are as defined above and, R3 represents a hydrophobic group.

3. A π-electron conjugate molecule-containing silicon compound according to claim 1, wherein R2 in said formula (I) or each of R2 and R3 in the formula (II) is a straight-chain hydrocarbon group having 1 to 30 carbon atoms.

4. A π-electron conjugate molecule-containing silicon compound according to claim 3, wherein said R3 is a straight-chain alkyl group having 1 to 30 carbon atoms.

5. A π-electron conjugate molecule-containing silicon compound according to claim 1, wherein said R1 is an organic group in which units constituting 3 to 10 π-electron conjugate systems are linearly combined.

6. A π-electron conjugate molecule-containing silicon compound according to claim 1, wherein said units constituting plural π-electron conjugate systems is selected from the group consisting of groups derived from a monocyclic aromatic hydrocarbon compound, a condensed polycyclic hydrocarbon, a monocyclic heterocyclic compound, a condensed heterocyclic compound, an alkene, an alkadiene, and an alkatriene and said R1 is an organic group in which one or more units selected from said group are combined linearly.

7. A π-electron conjugate molecule-containing silicon compound according to claim 6, wherein said unit constituting a π-electron conjugate system is a group derived from benzene or thiophene.

8. A method of producing a π-electron conjugate molecule-containing silicon compound comprising reacting a compound represented by the formula (III) or (IV):
R2-R1-R3-Z (III)
R2-R1-R3-Z (IV)
wherein R1 to R3 are as defined above and Z represents MgX, wherein X represents a halogen atom or Li, with a compound represented by the formula (V): 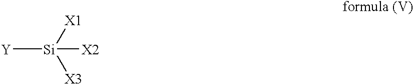
wherein X1 to X3 are as defined above and Y represents a hydrogen atom, a halogen atom or a lower alkoxy group
to produce the π-electron conjugate molecule-containing silicon compound represented by the formula (I) or (II): 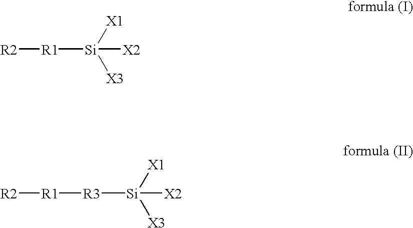
wherein R1 to R3 and X1 to X3 are as defined above.

9. A method of producing a π-electron conjugate molecule-containing silicon compound according to claim 8, wherein the group R is derived from a compound obtained by repeating a process one or more times in which a specified binding position of a raw material selected from a monocyclic aromatic hydrocarbon and a monocyclic heterocyclic compound is halogenated and then, the raw material is made to enter into a Grignard reaction to bind a specified number of the raw materials.

10. A method of producing a π-electron conjugate molecule-containing silicon compound according to claim 8, wherein the unit constituting the group R is derived from thiophene and the group R is derived from a compound obtained by repeating a process one or more times in which a specified binding position of thiophene is halogenated and then, obtained thiophene halides are reacted among them in the presence of NCS or POCl₃ to bind a specified number of thiophenes.

11. A method of producing a π-electron conjugate molecule-containing silicon compound according to claim 8, wherein the unit constituting the group R is derived from thiophene and the group R is derived from a compound obtained by repeating a process one or more times in which a specified binding position of thiophene is halogenated, then, obtained thiophene halide is reacted with divinylsulfone to obtain a 1,4-diketone body in which thiophene is bound with each side of the succinyl group and the 1,4-diketone body is made to enter into a ring-closure reaction in the presence of a Lawesson agent or P₄S₁₀ to bind a specified number of thiophenes.

12. A method of producing a π-electron conjugate molecule-containing silicon compound according to claim 8, wherein the group R is derived from a compound obtained by repeating a process one or more times in which a methyl group of a raw material selected from a monocyclic aromatic hydrocarbon and a monocyclic heterocyclic compound having the methyl group at a specified binding position is halogenated, then this halogen is substituted with a pentavalent phosphorous compound and the obtained compound is reacted with a raw material selected from a monocyclic aromatic hydrocarbon and a monocyclic heterocyclic compound having an aldehyde group at each specified position to bind a specified number of the raw materials.

13. Aπ-electron conjugate molecule-containing silicon compound according to claim 2, wherein R2 in said formula (I) or each of R2 and R3 in the formula (II) is a straight-chain hydrocarbon group having 1 to 30 carbon atoms.

14. A π-electron conjugate molecule-containing silicon compound according to claim 2, wherein said R1 is an organic group in which units constituting 3 to 10 π-electron conjugate systems are linearly combined.

15. A π-electron conjugate molecule-containing silicon compound according to claim 2, wherein said units constituting plural π-electron conjugate systems is selected from the group consisting of groups derived from a monocyclic aromatic hydrocarbon compound, a condensed polycyclic hydrocarbon, a monocyclic heterocyclic compound, a condensed heterocyclic compound, an alkene, an alkadiene, and an alkatriene and said R1 is an organic group in which one or more units selected from said group are combined linearly.
